(19) United States
(12) Patent Application Publication
(10) Pub. No.: US 2010/0147186 A1
(43) Pub. Date: Jun. 17, 2010

(54) Composition

(75) Inventors: Kersti Haugen, Vejle (DK); Peter Wisler, Dyssegaard (DK); Charlotte Johnson Vedel, Holte (DK)

Correspondence Address: STEPTOE & JOHNSON LLP, 1330 CONNECTICUT AVENUE, N.W., WASHINGTON, DC, 20036, US

(73) Assignee: Danisco A/S, Copenhagen K (DK)

(21) Appl. No.: 12/532,054

(22) PCT Filed: Mar. 12, 2008
(86) PCT No.: PCT/IB2008/001351

§ 371 Date: Feb. 10, 2010

(30) Foreign Application Priority Data
Mar. 27, 2007 (GB) 0705885.2

(51) Int. Cl. C09D 5/16

(52) U.S. Cl. 106/18.32

(57) ABSTRACT

There is provided a paint composition comprising i) a surface coating material; ii) a pigment; and iii) natamycin.

The present invention relates to a paint composition, methods of manufacturing the same, and use of an antimicrobial in the manufacture of the same.

As discussed in U.S. Pat. No. 5,071,479 biocides are required in many different environments, such as anti-fungal agents in house paints, fresh water algicides, and anti-fouling agents for marine structures exposed to sea water, flora and fauna. As is known, mildew or fungus may grow on house paints and the like, and utilises the paint medium as a nutrient, or in some cases the underlying substrates, such as wood, as the nutrient. For obvious reasons, this may cause damage to the painted surface and/or deterioration in the appearance of the painted surface. A biocide may be incorporated in the paint and when the mycelia and fruiting bodies of the fungi contact or penetrate the paint film and thus, through intimate contact with the biocide in the film, the fungi are destroyed.

However, there is a growing concern about the environmental effects of using such organic biocides. For instance, a widely used traditional biocide, tributyl tin oxide, is a moderately to highly acute endocrine disruptor, which has been shown to have such adverse effects as reproductive failure and population decline in Pacific oysters and dog whelks. In addition, further environmental concerns have led to a move to reduce the level of solvents in paint.

In order to address the growing environmental concerns with regard to the formulation of paints, the industry as a whole has been moving to water-based paints with much reduced solvent levels. These paints are far more permissive for fungal, algal and bacterial growth, all of which lead to spoilage of the paint. Degradation and spoilage of paint is a major issue for the paint industry with a large percentage spoilt shortly after production as a result of microbial contamination and growth.

The present invention helps to address the problem of microbial growth in paint, whilst providing a solution that does not have the negative environmental impact of the biocides commonly used in the art. Accordingly, the invention provides paint compositions, methods of manufacturing paint compositions, and use of a specific antimicrobial in the manufacture of paint compositions.

In one aspect the present invention provides a paint composition comprising: i) a surface coating material; ii) a pigment; and iii) natamycin.

In a further aspect the present invention provides a method for the preparation of a paint composition, comprising the step of contacting i) a surface coating material; ii) a pigment; and iii) natamycin.

In a further aspect the present invention provides a method for preventing microbial growth on a surface, comprising the step of coating the surface with a paint composition comprising: i) a surface coating material; ii) a pigment; and iii) natamycin.

In a further aspect the present invention provides a method for preventing microbial growth in a paint composition, comprising the step of contacting the components of the paint composition with natamycin.

In a further aspect the present invention provides use of natamycin for providing antimicrobial action in a paint composition. Preferably the paint composition comprises i) a surface coating material; ii) a pigment; and iii) natamycin.

An advantage of the present invention is that a paint composition may be provided which provides and antimicrobial effect in respect of the surface to be treated while reducing the need for, or avoiding completely, antimicrobial materials which are potentially harmful to the environment. The present invention provides a system in which an antimicrobial material is provided which is food safe. Consequently the paint may be used in situation where high safely levels are required with respect to toxicity, for example for application to object to which children have access.

A yet further advantage or alternative advantage of the invention is that a paint composition may be provided which on storage protections against antimicrobial growth is provide with the use of or reducing the use of protectant materials which are harmful to the environment or which are toxic. The natamycin antimicrobial of the present paint composition is food safe so the present invention may provide a paint which is less toxic than those preserved with prior art systems. Moreover, of the other components of the paint are chosen such they are food safe, an paint composition may be provided which is itself food safe.

For ease of reference, these and further aspects of the present invention are now discussed under appropriate section headings. However, the teachings under each section are not necessarily limited to each particular section.

### Natamycin

As discussed here, the present paint composition comprises natamycin. Natamycin is a polyene macrolide natural antifungal agent produced by fermentation of the bacterium Streptomyces natalensis. Natamycin (previously known as pimaricin) has an extremely effective and selective mode of action against a very broad spectrum of common food spoilage yeasts and moulds with most strains being inhibited by concentrations of 1-15 ppm of natamycin.

Natamycin is accepted as a food preservative and used world wide, particularly for surface treatment of cheese and dried fermented sausages. It has several advantages as a food preservative, including broad activity spectrum, efficacy at low concentrations, lack of resistance, and activity over a wide pH range.

A general description of natamycin and its current uses may be found in Thomas, L. V. and Delves-Broughton, J. 2003. Natamycin. In: Encyclopedia of Food Sciences and Nutrition. Eds. B. Caballero, L. Trugo and P. Finglas, pp 4109-4115. Elsevier Science Ltd.

The natamycin for use in the present invention may be produced in accordance with any suitable process. For example the natamycin may be prepared as discussed above by fermentation of the bacterium Streptomyces natalensis. The natamycin in one alternative may be prepared from a organism modified such that it expresses natamycin.

Natamycin is available as Natamax® from Danisco A/S, Denmark.

The natamycin may be present in ay suitable amount to achieve the desired effect.

In one aspect the natamycin is present in an amount to provide an antifungal effect (such as a fungicidal or fungistatic effect) in the paint composition. In one aspect the natamycin is present in an amount to provide an antifungal effect (such as a fungicidal or fungistatic effect) on the surface coated with the paint composition.

In one aspect the natamycin is present in an amount to provide an antibacterial effect (such as a bactericidal or a bacteriostatic effect) in the paint composition. In one aspect the natamycin is present in an amount to provide an antibacterial effect (such as a bactericidal or a bacteriostatic effect) on the surface coated with the paint composition.

In one aspect the natamycin is present in an amount to provide an antialgal effect (such as a algicidal or algistatic effect) in the paint composition. In one aspect the natamycin is present in an amount to provide an antialgal effect (such as a algicidal or algistatic effect) on the surface coated with the paint composition.

In one aspect the natamycin is present in an amount to provide a virucidal effect in the paint composition. In one aspect the natamycin is present in an amount to provide a virucidal on the surface coated with the paint composition.

In one aspect the natamycin is present in an amount to provide a sporicidal effect in the paint composition. In one aspect the natamycin is present in an amount to provide a sporicidal on the surface coated with the paint composition.

In one aspect the natamycin is present in an amount of at least 10 ppm based on the paint composition. Preferably the natamycin is present in an amount of at least 20 ppm based on the paint composition. Preferably the natamycin is present in an amount of at least 50 ppm based on the paint composition. For example the natamycin may be present in an amount of at least 100 ppm based on the paint composition.

In one aspect the natamycin is present in an amount of 0.1 to 200 ppm based on the paint composition, such as 0.1 to 100 ppm based on the paint composition, such as 0.2 to 100 ppm based on the paint composition, such as 0.5 to 80 ppm based on the paint composition, such as 1 to 50 ppm based on the paint composition, such as 5 to 10 ppm based on the paint composition, such as 10 to 200 ppm based on the paint composition, such as 10 to 100 ppm based on the paint composition, 20 to 200 ppm based on the paint composition, 50 to 200 ppm based on the paint composition, 20 to 80 ppm based on the paint composition, 30 to 70 ppm based on the paint composition, 50 to 100 ppm based on the paint composition, or 100 to 200 ppm based on the paint composition.

In one aspect the natamycin is encapsulated or microencapsulated.

The encapsulating material may be selected from the group comprising hydrocolloids, shellac, zein, any synthetic or natural water-soluble polymers, any water-insoluble microparticles, such as silicone dioxide, titanium dioxide, synthetic or natural food-grade polymer beads or any water-insoluble solid particles which have a suitable size and mixtures thereof.

Preferably the hydrocolloid is selected from sodium alginate, gum arabic, gellan gum, starch, modified starch, guar gum, agar gum, pectin, amidified pectin, carrageenan, gelatine, chitosan, mesquite gum, hyaluronic acid, cellulose derivatives such as cellulose acetate phtalate, hydroxy propyl methylcellulose (HPMC), methyl cellulose, ethyl cellulose and carboxy methyl cellulose (CMC), methyl acrylic copolymers, such as Eudragit®, psyllium, tamarind, xanthan, locust bean gum, xanthan/locust bean gum mixture, whey protein, soy protein, sodium caseinate, any food-grade protein and mixtures thereof.

### Paint

As discussed herein, the paint composition should contain at least i) a surface coating material; ii) a pigment; and iii) natamycin. The paint composition may (or may) contain materials in addition to this.

The present invention is particularly advantageous for use with paints containing water or a high proportion of water. The paints tend to offer an attractive environment for microbial growth. Such water based paints when stored over time often deteriorate because of microbial growth and in particular fungal growth. Thus in one preferred aspect the paint composition of the present invention is water based.

Preferably the paint composition contains water in an amount of 10 to 90% by weight based on the paint composition. The paint composition may contain water in an amount of 20 to 80% by weight based on the paint composition, such as 20 to 60% by weight based on the paint composition, such as 30 to 70% by weight based on the paint composition, such as 40 to 80% by weight based on the paint composition, such as 50 to 80% by weight based on the paint composition, such as 30 to 60% by weight based on the paint composition, such as 40 to 70% by weight based on the paint composition, or such as 50 to 70% by weight based on the paint composition.

Any additional components may be added to the paint composition, for example to provide the desired properties in the paint composition. For example, the paint composition may further comprising one or more antimicrobials in addition to the natamycin.

Examples of trade recognized coating materials are polyvinyl chloride resins in a solvent based system, chlorinated rubbers in a solvent based system, acrylic resins and methacrylate resins in solvent based or aqueous systems, vinyl chloride vinyl acetate copolymer systems as aqueous dispersions or solvent based systems, butadiene copolymers such as butadiene styrene rubbers, butadiene acrylonitrile rubbers, and butadiene styrene acrylonitrile rubbers, drying oils such as linseed oil, alkyd resins, asphalt, epoxy resins, urethane resins, polyester resins, phenolic resins, derivatives and mixtures thereof.

Examples of pigments are inorganic pigments, such as titanium dioxide, ferric oxide, silica, talc, or china clay, organic pigments such as carbon black or dyes, derivatives and mixtures thereof.

In the context of the present invention the term “anti-microbial” is intended to mean that there is a bactericidal and/or a bacteriostatic effect and/or algicidal and/or “algistatic” effect and/or fungicidal and/or fungistatic effect and/or a virucidal effect and/or a sporicidal effect, wherein the terms bactericidal bacteriostatic, fungicidal, fungistatic, virucidal and sporicidal are as defined herein.

The term “bactericidal” is to be understood as capable of killing bacterial cells.

The term “bacteriostatic” is to be understood as capable of inhibiting bacterial growth, i.e. inhibiting growing bacterial cells.

The term “algicidal” is to be understood as capable of killing algae.

The term “algistatic” is to be understood as capable of inhibiting algal growth, i.e. inhibiting growing algae.

The term “fungicidal” is to be understood as capable of killing fungal cells.

The term “fungistatic” is to be understood as capable of inhibiting fungal growth, i.e. inhibiting growing fungal cells.

The term “virucidal” is to be understood as capable of inactivating virus.

The term “sporicidal” is to be understood as capable of inactivating spores.

The term “microbes” denotes bacterial or fungal cells or a bacterium or fungi.

The paint compositions of the present invention may be formulated as coatings, lacquers, stains, enamels and the like, hereinafter referred to generically as “coating(s)”.

Thus, in one aspect the present invention provides a coating consisting of a composition as defined above.

Preferably, the paint composition is formulated for treatment of a surface selected from indoor and outdoor surfaces, in particular indoor walls and surfaces. Preferably the paint composition is suitable for painting of an indoor surface and in particular and indoor wall.

The paint composition may include a liquid vehicle (solvent) for dissolving or suspending the components of the composition.

The liquid vehicle may be selected from any liquid which does not interfere with the activities of any essential components of the composition. Suitable liquid vehicles are disclosed in U.S. Pat. No. 5,071,479 and include water and organic solvents including aliphatic hydrocarbons, aromatic hydrocarbons, such as xylene, toluene, mixtures of aliphatic and aromatic hydrocarbons having boiling points between 100 and 320° C., preferably between 150 and 230° C.; high aromatic petroleum distillates, e.g., solvent naptha, distilled tar oil and mixtures thereof; alcohols such as butanol, octanol and glycols; vegetable and mineral oils; ketones such as acetone; petroleum fractions such as mineral spirits and kerosene, chlorinated hydrocarbons, glycol esters, glycol ester ethers, derivatives and mixtures thereof.

The liquid vehicle may contain at least one polar solvent, such as water, in admixture with an oily or oil-like low-volatility organic solvent, such as the mixture of aromatic and aliphatic solvents found in white spirits, also commonly called mineral spirits.

The vehicle may typically contain at least one of a diluent, an emulsifier, a wetting agent, a dispersing agent or other surface active agent. Examples of suitable emulsifiers are disclosed in U.S. Pat. No. 5,071,479 and include nonylphenol-ethylene oxide ethers, polyoxyethylene sorbitol esters or polyoxyethylene sorbitan esters of fatty acids, derivatives and mixtures thereof.

Any suitable surface coating material may be incorporated in the composition and/or coating of the present invention. Examples of trade-recognized coating materials are polyvinyl chloride resins in a solvent based system, chlorinated rubbers in a solvent based system, acrylic resins and methacrylate resins in solvent based or aqueous systems, vinyl chloride-vinyl acetate copolymer systems as aqueous dispersions or solvent based systems, butadiene copolymers such as butadiene-styrene rubbers, butadiene-acrylonitrile rubbers, and butadiene-styrene-acrylonitrile rubbers, drying oils such as linseed oil, alkyd resins, asphalt, epoxy resins, urethane resins, polyester resins, phenolic resins, derivatives and mixtures thereof.

The composition and/or coating of the present invention may contain plasticisers, rheology characteristic modifiers, other conventional ingredients and mixtures thereof.

The composition and/or coating of the present invention, particularly the coating, further comprise an adjuvant conventionally employed in compositions used for protecting materials exposed to an aquatic environment. These adjuvants may be selected from additional fungicides, auxiliary solvents, processing additives such as defoamers, fixatives, plasticisers, UV-stabilizers or stability enhancers, water soluble or water insoluble dyes, color pigments, siccatives, corrosion inhibitors, thickeners or anti-settlement agents such as carboxymethyl cellulose, polyacrylic acid or polymethacrylic acid, anti-skinning agents, derivatives and mixtures thereof.

The additional fungicide(s) used in the composition and/or coating of the present invention is preferably soluble in the liquid vehicle.

The composition of the present invention can be provided as a ready-for-use product or as a concentrate. The ready-for-use product may be in the form of an aqueous solution, aqueous dispersion, oil solution, oil dispersion, emulsion, or an aerosol preparation. The concentrate can be used, for example, as an additive for coating, or can be diluted prior to use with additional solvents or suspending agents.

An aerosol preparation according to the invention may be obtained in the usual manner by incorporating the composition of the present invention comprising or dissolved or suspended in, a suitable solvent, in a volatile liquid suitable for use as a propellant, for example the mixture of chlorine and fluorine derivatives of methane and ethane commercially available under the trademark “Freon”, or compressed air.

As discussed in U.S. Pat. No. 5,071,479 the composition and/or coating of the present invention may include additional ingredients known to be useful in preservatives and/or coatings. Such ingredients include fixatives such as carboxymethylcellulose, polyvinyl alcohol, paraffin, co-solvents, such as ethylglycol acetate and methoxypropyl acetate, plasticisers such as benzoic acid esters and phthlates, e.g., dibutyl phthalate, dioctyl phthalate and didodecyl phthalate, derivatives and mixtures thereof. Optionally dyes, color pigments, corrosion inhibitors, chemical stabilizers or siccatives (dryers) such as cobalt octate and cobalt naphthenate, may also be included depending on specific applications.

In one aspect the paint composition is an oil paint and in particular a linseed oil paint.

Oil paints: Oil paints can be made from linseed oil or they can be based on wood tar or fish oil. Linseed oil are typically used on wood, it contains linseed oil which can either be boiled linseed oil (linseed varnish) or raw linseed oil, pigments and if necessary the paint can also contain a drier or siccative.

Linseed oil paint can be made by adding 1 litre of boiled linseed oil to about 500 gram of pigments, the amount of pigment depends on the colour and the oil. A thick paste is mixed followed by addition of more linseed oil until the oil paint has a consistency applicable to paint on a surface. If necessary maximum 7 percent of drier or siccative can be added to decrease the drying period. The boiled linseed oil can be replaced by raw linseed oil. Natamycin can be added either during the mixing process and/or after mixing to preserve the top surface of a paint container.

The composition and/or coating of the present invention can be applied by any of the techniques known in the art including brushing, spraying, roll coating, dipping and combinations thereof.

Compositions of the present invention can be prepared simply by mixing the various ingredients at a temperature at which they are not adversely affected. Preparation conditions are not critical. Equipment and methods conventionally employed in the manufacture of coating and similar compositions can be advantageously employed. Microbial contamination such as fungal contamination in paint can decrease the shelf-life of paints, an in particular water based paints or oil paints as the microbes such as fungi are able to grow on the surface of the paint in the container. Natamycin can be either mixed into the paint or added on top of the paint before closing the container.

As discussed herein, the paint composition of the present invention typically contains a pigment. However, it is found that the composition of the present invention may be used in the same manner as a paint to achieve the desired anti-microbial effect on a surface, such as a wall, without the need for a pigment to be present. For example the present invention may be used to treat a surface, such as a bathroom wall, to prevent/inhibit microbial growth, such as algal growth. Thus in further aspects, the present invention provides:
A composition comprising: i) a surface coating material; and ii) natamycin.
A method for the preparation of a composition, comprising the step of contacting i) a surface coating material; and ii) natamycin.
A method for preventing microbial growth on a surface, comprising the step of coating the surface with a composition comprising: i) a surface coating material; and ii) natamycin.
A method for preventing microbial growth in a composition, comprising the step of contacting the components of the composition with natamycin.

Each of the features of the present invention described here with reference to compositions containing pigment equally apply to the above aspects of the invention.

The invention will now be described, by way of example only, in the following Examples.

### EXAMPLES

### Example 1

A base paint composition is prepared in accordance with the teaching of WO00/68324. The base paint composition contains the following components.

| Compound | Suitable Types | Amount | |
|---|---|---|---|
| Binder | | 10-30% | w/w |
| | Acryl-styrene | | |
| | Acrylate | | |
| | Acrylate copolymers | l | |
| | Polyvinylacetate | | |
| Pigments | | 10-25% | w/w |
| | TiO₂ | | |
| | Other pigments | | |
| Solvent | | 0-2% | w/w |
| | White spirit | | |
| | Butyl glycol | | |
| | Butyl diglycol | | |
| | Propylene glycol | | |
| | Ethylene glycol | | |
| | Texanol | | |
| | Ammonia | | |
| Filler | | 15-30% | w/w |
| | Calcium carbonate | | |
| | Talc | | |
| | Aluminum silicate | | |
| | Dolomite | | |
| Viscosifier | | 0.1-2% | w/w |
| | Hydroxyethylcelluose | | |
| | Polyacrylates | | |
| | Polyurethaner | | |
| Dispersant | | 1-3% | w/w |
| | Soy lecithin | | |
| | Acrylic acid/sodium | | |
| | hydroxide | | |
| | Polyglycolethers or esters | | |
| | Octyl-or | | |
| | nonylphenolethoxylates | | |
| | Tripolyphosphate | | |
| Foam | | 0.2-0.5% | w/w |
| suppresser | | | |
| | Mineral oil | | |
| | Silicone oil | | |
| | Fatty acid esters | | |
| Siccatives | | 0.1-0.5% | w/w |
| | Cobalt octoate | | |
| | Zirkonium octoate | | |
| | Calcium naphtenate | | |
| | Zinc naphtenate | | |
| Water | | 30-50% | w/w |

Four compositions are prepared and tested. They are a control containing no protectant and compositions in accordance with the present invention containing 10 ppm, 25 ppm and 50 ppm natamycin. The natamycin is Natamax available from Danisco A/S, Denmark. 490 g of paint is divided into 4 small plastic containers, with 120 g in each. Natamycin, in the different concentrations, is then added to the paint and mixed. Natamycin is not added to the control.

The 4 containers are inoculated with the pool of moulds described below. From each container 3 wooden plywood boards (9.5 cm×9.5 cm) are painted with approximately 2 g. of paint.

### Samples

The following samples are prepared (in duplicate) in containers and on the plywood boards

| | | |
|---|---|---|
| 0 | Blind (only on boards) | |
| 1 | Control | 100 g paint + inoculum |
| 2 | Sample with 10 ppm of | 120 g paint + 0.0024 g |
| | Natamax | Natamax + inoculum |
| 3 | Sample with 25 ppm of | 120 g paint + 0.0060 g |
| | Natamax | Natamax + inoculum |
| 4 | Sample with 50 ppm of | 120 g paint + 0.0120 g |
| | Natamax | Natamax + inoculum |

### Inoculation/Contamination:

### Indicator Strains:

The following indicator strains are tested. The chosen species are found growing both in paints and bathrooms:

Aureobasidium pullulans DSM No. 6402
Phoma asicola DSM No. 62895
Cladosporium herbarum CBS 134.31

(All Strains are Available from the Strain Collections DSM and CBS)

### Inoculation Rates:

100 CFU/g paint

Pool of moulds—all 3 strains of moulds contribute with ⅓ to an end CFU of 100 CFU/g paint

### Inoculation:

Samples 1-4 are inoculated with the pool of moulds described above.

Sample 1, with only 100 g of paint, compared to 120 of the others, is inoculated with ⅙ less CFU.

### Storage:

In can: 25° C.

On wall: humidity >90%, temperature 25° C.

### Detection

Growth of moulds are detected visually—by eye and by photos.

Differences in growth between the control and the Natamax samples are described in the matter of:
growth/no growth
numbers of moulds (if countable) or area covered with moulds.
Colors of moulds (to see which moulds grows)

### Detection Days:

Day₀ and then 3 times a week, starting with day 5. The monitoring stops when no additional data occurs.

The following standards are also available for determining the resistance to fungal growth in a paint:

BS3900-G6 (British standard)

### VdL-RL06 (Verband der Lackindustrie)

### Example 2

### Test on Wood-Boards

Three different strains were added to paint with Natamycin, the total inoculation was approximately 100 CFU/g paint. The paint was Acrylic Emulsion Paint Based on Primal CM219EF available from PRA Coatings Technology Centre, Hampton, Middlesex, UK. Each strain represents approximately ⅓ of the total CFU. Natamycin was provided by Danisco as Natamax Product No. 104417.

| | | Natamycin, mg | Paint/g on wood |
|---|---|---|---|
| Sample nr: | From sample: | in 100 g paint | board |
| A0 | Raw paint | — | 1.37 |
| B0 | Raw paint | — | 1.37 |
| C0 | Raw paint | — | 1.72 |
| D1 | 1 | — | 2.23 |
| E1 | 1 | — | 2.35 |
| F1 | 1 | — | 1.91 |
| G2 | 2 | 10 | 2.12 |
| H2 | 2 | 10 | 2.11 |
| I2 | 2 | 10 | 2.11 |
| J3 | 3 | 25 | 1.99 |
| K3 | 3 | 25 | 1.97 |
| L3 | 3 | 25 | 2.09 |
| M4 | 4 | 50 | 2.13 |
| N4 | 4 | 50 | 2.14 |
| O4 | 4 | 50 | 2.08 |

The following indicator strains were tested by providing a mixture of the strains in a ratio of 1:1:1. The chosen species are found growing both in paints and bathrooms:

Aureobasidium pullulans DSM No. 6402
Phoma asicola DSM No. 62895
Cladosporium herbarum CBS 134.31
(All Strains are Available from the Strain Collections DSM and CBS)

The 1:1:1 mixture was used to inoculate each of samples D1 to O4. The inoculation was as described in Example 1. As noted above the total inoculation was approximately 100 CFU/g paint. Thus each strain was present in each sample in an amount of approximately 33 CFU/g paint.

The painted boards were stored at 25° C. at a humidity of at least 90%. The growth on the painted boards was detected visually by eye, and the number of colonies were counted.

Results from Wood-Boards:

| Sample* | 1 week | 2 weeks | 3 weeks | 4 weeks |
|---|---|---|---|---|
| 0 Blind | 0/0/0 | 3/3/3 | 4/4/4 | 4/4/4 |
| 1 Control | 0/0/0 | 3/3/3 | 4/4/4 | 4/4/4 |
| 2 Natamax (10 ppm) | 0/0/0 | 1/1/1 | 3/3/4 | 4/4/4** |
| 3 Natamax (25 ppm) | 0/0/0 | 0/0/1 | 2/2/2 | 4/3/3 |
| 4 Natamax (50 ppm) | 0/0/0 | 0/0/0 | 0/0/1 | 0/0/2 |

*all samples were tested in triplets, incubated at 25° C. at a humidity >90%
**board was full of growth but with smaller colonies than control and blind
0: No detectable growth
1: less than 4 colonies on the board
2: less than 9 colonies on the board
3: more than 9 colonies on the board
4: Board full of moulds

### Example 3

### Test in Paint Cans

| Sample nr | Natamycin, mg |
|---|---|
| 1.1 | 0 (control) |
| 1.2 | 0 (control) |
| 2.1 | 10 |
| 2.2 | 10 |
| 3.1 | 25 |
| 3.2 | 25 |
| 4.1 | 50 |
| 4.2 | 50 |

To all samples was added a pool of moulds approximately 100 CFU/g paint. The paint was Acrylic Emulsion Paint Based on Primal CM219EF available from PRA Coatings Technology Centre, Hampton, Middlesex, UK.

The strains including types, amounts and inoculation were as described in Example 2.

Results from Preservation of Water-Based Paint

Results are shown as the average number of colony counts on the surface of the paint in the cans.

| Sample | 1 week | 2 weeks | 3 weeks | 4 weeks |
|---|---|---|---|---|
| 1 Control | 4 | 4 | 4 | 5.5 |
| 2 Natamax (10 ppm) | 0 | 0.5 | 2 | 3 |
| 3 Natamax (25 ppm) | 0 | 1 | 2 | 3 |
| 4 Natamax (50 ppm) | 0 | 0 | 0 | 0.5 |

The control without added Natamycin was contaminated with fungi already after 1 week, natamycin significantly inhibited the growth on the paint surface.

All publications mentioned in the above specification are herein incorporated by reference. Various modifications and variations of the described methods and system of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention which are obvious to those skilled in chemistry or related fields are intended to be within the scope of the following claims

1. A paint composition comprising:
i) a surface coating material;
ii) a pigment; and
iii) natamycin.

2. A paint composition according to claim 1 wherein the natamycin is present in an amount of at least 10 ppm based on the paint composition.

3. A paint composition according to claim 1 wherein the natamycin is present in an amount of at least 20 ppm based on the paint composition.

4. A paint composition according to claim 1 wherein the natamycin is present in an amount of at least 50 ppm based on the paint composition.

5. A paint composition according to claim 1 wherein the natamycin is present in an amount of at least 100 ppm based on the paint composition.

6. A paint composition according to claim 1 wherein the natamycin is present in an amount of 10 to 100 ppm based on the paint composition.

7. A paint composition according to claim 1 wherein the natamycin is encapsulated or microencapsulated.

8. A paint composition according to claim 1 wherein the natamycin is present in an amount to provide an antifungal effect.

9. A paint composition according to claim 1 further comprising one or more antimicrobials in addition to the natamycin.

10. A paint composition according to claim 1 wherein the paint composition is water based.

11. A paint composition according to claim 1 wherein the paint composition contains water in an amount of 10 to 90% by weight based on the paint composition.

12. A paint composition according to claim 1 wherein the paint composition contains water in an amount of 20 to 80% by weight based on the paint composition.

13. A paint composition according to claim 1 wherein the paint composition is suitable for painting of a wooden surface.

14. A method for the preparation of a paint composition, comprising the step of contacting
i) a surface coating material;
ii) a pigment; and
iii) natamycin.

15. (canceled)

16. A method for preventing microbial growth on a surface, comprising the step of coating the surface with a paint composition comprising:
i) a surface coating material;
ii) a pigment; and
iii) natamycin.

17. (canceled)

18. A method for preventing microbial growth in a paint composition, comprising the step of contacting the components of the paint composition with natamycin.

19. (canceled)

20. Use of natamycin for providing antimicrobial action in a paint composition.

21. Use according to claim 18 wherein the paint composition comprises
i) a surface coating material;
ii) a pigment; and
iii) natamycin.

22-27. (canceled)
